(19) United States
(12) Patent Application Publication
(10) Pub. No.: US 2006/0172117 A1
(43) Pub. Date: Aug. 3, 2006

(54) Glare reducing film

(76) Inventor: Steven R. Petersen, Rochester, MN (US)

Correspondence Address: Dunlap & Seeger, P.A.;Suite 505, 206 South Broadway, P.O. Box 549, Rochester, MN, 55903-0549, US

(21) Appl. No.: 11/045,663

(22) Filed: Jan. 31, 2005

(51) Int. Cl. B32B 3/10

(52) U.S. Cl. 428/138; 428/174

(57) ABSTRACT

A glare reducing film is provided for application to the screen of a television, computer and the like to reduce or eliminate glare from the screen caused by external sources such as windows and room lighting. The film comprises a thin film of clear flexible plastic material such as polyvinyl chloride having a matted front surface and a smooth back surface. The film is perforated to permit the passage of air through the film between the front surface and the back surface. The back surface is covered by a removable backing which is slit diagonally from corner to corner. The film may be formed in a convex shape corresponding to the general shape of the screen to be covered. To apply the film, the screen is cleaned of all dust and other foreign particles and wetted with a moistening agent such as water or glass cleaner. The central corners of the backing portions are peeled away from the back surface of the film to expose a small area in the center of the back surface. The exposed area is pressed onto the screen and the film is properly positioned on the screen. Once properly positioned, the remaining backing portions are removed and as they are removed, the film is pressed against the screen from the center outwardly to remove any bubbles between the film and the screen, until the film is fully pressed into position on the screen.

### BACKGROUND OF THE INVENTION

The present invention generally relates to a glare reducing film particularly useful in conjunction with television and computer screens to reduce glare from outside light sources reflected by the screen.

### BRIEF SUMMARY OF THE INVENTION

Most screens for televisions, computers and the like in use today have an outer surface which reflects light from external sources such as windows and room lighting. These reflections cause glare which interferes with clearly viewing the images or information being displayed on the screen.

Some screens have been produced with non-glare surfaces which tend to reduce this problem. But most screens in use today do not have such non-glare surfaces.

Traditionally, such screens have been formed with curved surfaces. This results in reflections from a wider angle, resulting in increased glare. Some screens have been produced with flat surfaces in an attempt to minimize the glare problem, but some reflections still occur, albeit from a narrower range.

The present invention is designed to be used with screens for televisions, computers and the like which do not have non-glare surfaces, regardless of whether such screens have a curved surface or a flat surface, to reduce glare from external sources to thereby facilitate viewing of images and information displayed on such screens.

It is one object of the present invention to provide a transparent film of clear plastic material having a non-glare surface which may be applied to cover a screen of a television, computer or the like to reduce or eliminate glare from the screen.

It is another object of the present invention to provide a glare reducing film which may be applied over the outer surface of a screen for a television, computer or the like and which will there remain in place for an extended period of time.

It is another object of the present invention to provide a glare reducing film which may be applied to the outer surface of a screen for a television, computer or the like having perforations defined through the film to permit the passage of air to eliminate air bubbles being formed between the film and the screen when the film is applied to the screen.

To those ends, a glare reducing film comprised of a suitable clear plastic material is provided having a non-glare surface on one face and a removable backing on its other face. The film is sized to correspond to the approximate dimensions of the screen upon which it will be placed. The film has a number of perforations defined through it at even intervals to permit the passage of air therethrough. The film is applied to the screen by removing the backing from the film, wetting the surface of the screen with water or some other suitable liquid and pressing the back of the film onto the surface of the screen. The perforations permit the passage of air to eliminate bubbles being formed between the film and the screen. The film adheres to the screen even after the wetting agent has evaporated by natural adhesion of the film to the screen. In the case of film designed for use on a curved screen, a convex curve is imparted to the film during manufacture to promote adhesion of the film to the screen once in place on the screen.

### DESCRIPTION OF THE DRAWING

FIG. 1 is a front elevational view showing a glare reducing film according to the present invention prior to placement on a television or computer screen.

FIG. 2 is a fragmented front view of a corner of a glare reducing film according to the present invention showing perforations spaced uniformly along the film.

FIG. 3 is a fragmented side sectional view of a portion of a glare reducing film according to the present invention for use in conjunction with a screen having a curved surface.

FIG. 4 is a fragmented side sectional view of a portion of a glare reducing film according to the present invention for use in conjunction with a screen having a flat surface.

FIG. 5 is an exploded front elevational view of a glare reducing film according to the present invention showing the backing spaced from the film.

FIG. 6 is a rear elevational view of a glare reducing film according to the present invention showing the backing being partially peeled away from the film.

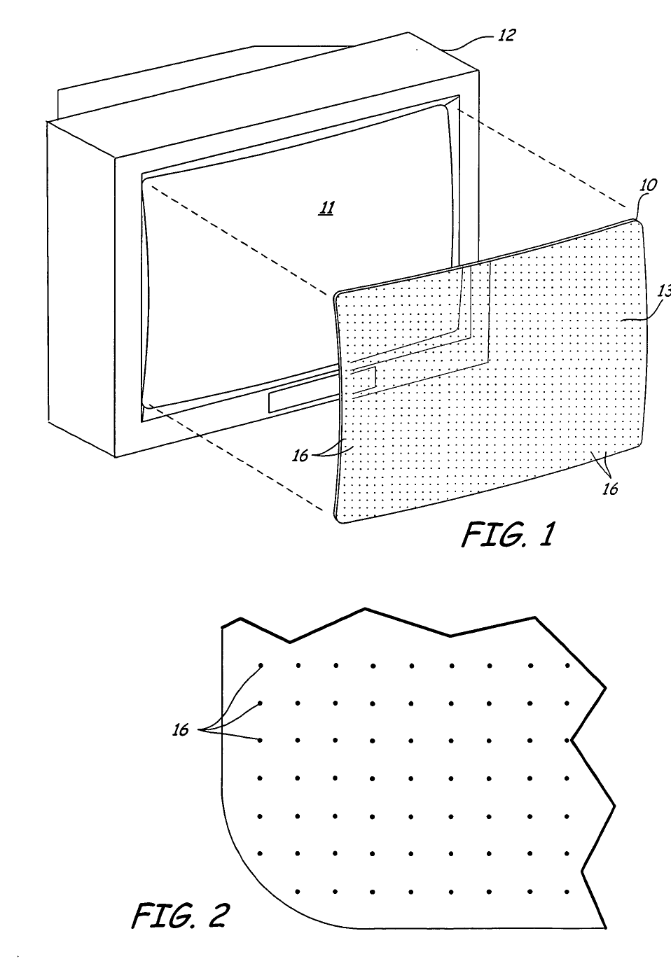

### DETAILED DESCRIPTION OF THE PREFERRED EMBODIMENT

Referring to the drawing, wherein like numerals represent like elements throughout the several views, there is shown a glare reducing film generally designated by the numeral 10 in relation to the screen 11 of a television 12. Film 10 comprises a clear, flexible plastic material, preferably polyvinyl chloride, similar to that used in window decals, and has a thickness of approximately 0.004-0.006 of an inch. It is a characteristic of such material that it will adhere to smooth surfaces such as glass and other plastics. Film 10 is sized according to the size of the screen 11 of the particular television 12, computer or other device on which it will be used.

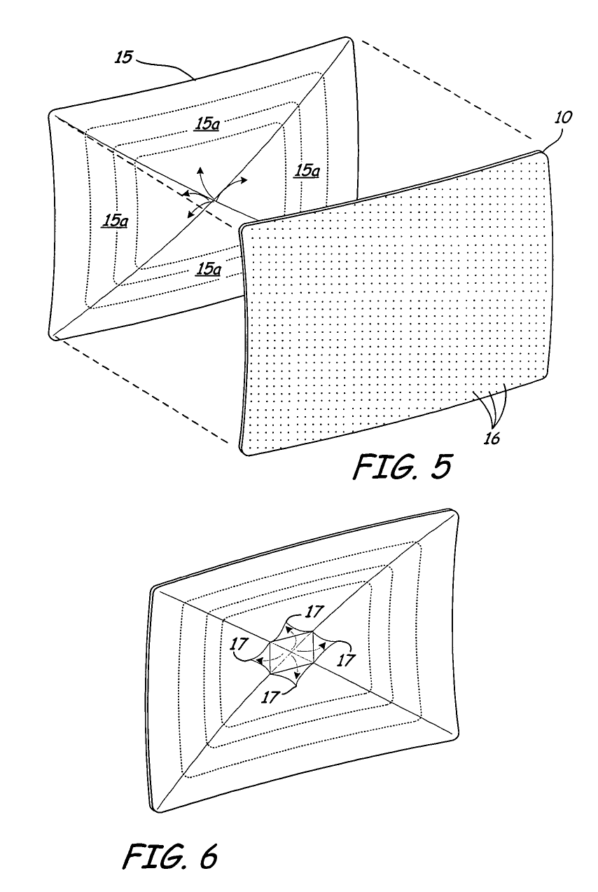

Film 10 has a front surface 13 and a back surface 14. Front surface 13 is roughened and matted, resulting in a non-glare surface. Back surface 14 is flat and smooth and covered by a backing 15 of paper or some other suitable material. Backing 15 is scored diagonally from corner to corner as shown in FIGS. 5 and 6 to define portions 15a which may be peeled off the back surface 14 from the center outward, as best shown in FIG. 6. The score lines may be marked or shown on the backing 15 to help align the film 10 during placement.

Film 10 is punctured or slit to form perforations 16 uniformly spaced through film 10 from back surface 14 to front surface 13. The perforations 16 permit the passage of air through film 10 as it is applied to the screen 11. Perforations 16 are formed when the film 10 is produced, by conventional methods.

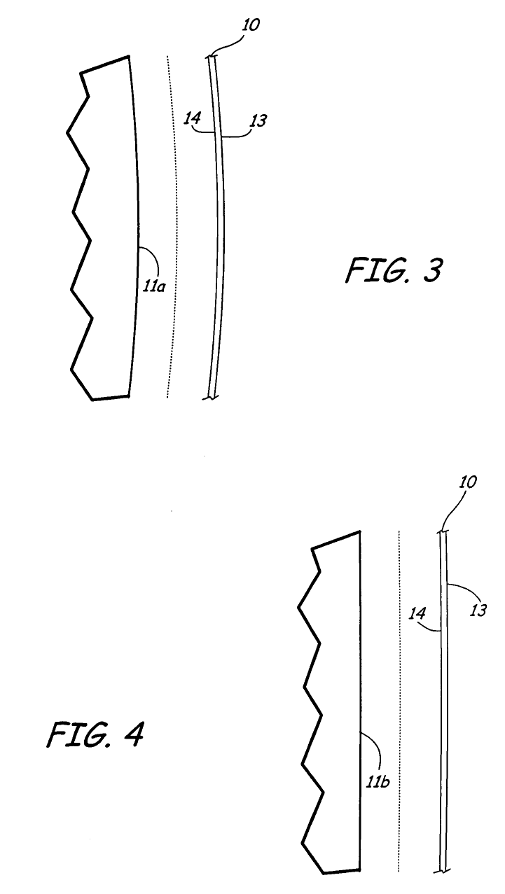

As best seen in FIG. 3, in the case of a film 10 to be used in conjunction with a device having a curved screen 11a, a convex curve is imparted to the film 10 corresponding generally to the degree of concavity of the screen 11a. This facilitates adherence of the film 10 to the screen 11a. Similarly, and as best seen in FIG. 4, in the case of a film 10 to be used in conjunction with a device having a flat screen 11b, the film 10 is formed flat. This also facilitates adherence of the film 10 to the screen 1b.

To place the film 10 on a screen 11, a film 10 having the same general dimensions and configuration (i.e., flat or convex) as the screen 11 is selected. The screen 11 is cleaned thoroughly to remove any dust or foreign particles from its surface. The screen 11 is then moistened with a moistening agent such as misted water. The central ends 17 of backing portions 15a are peeled partially away (as shown in FIG. 6) until a sufficient area of the back surface 14 of film 10 is exposed. The exposed area of back surface 14 is then pressed into adhering relation to the center of the screen 11. Because of the moistening agent, the position of the film 10 with respect to the screen 11 may be adjusted by sliding the film 10 until it is properly positioned on the screen 11. Once the film 10 is properly positioned on the screen 11, backing portions 15a are peeled from the back surface 14 in the manner shown and as the portions 15a are peeled back, the film 10 is pressed against the screen 11 outwardly from the center. Perforations 16 permit the passage of air through the film 10 to eliminate bubbles that might otherwise be created between the film 10 and screen 11 during the positioning process. Perforations 16 also permit the evaporation of the moistening agent from between the film 10 and screen 11 once the film 10 is finally positioned on the screen 11. The natural tendency of the film 10 to adhere to flat, smooth surfaces will cause the film 10 to remain in position on the screen 11 for an indefinite period. The film 10 can be removed from the screen 11 simply by lifting a corner of film 10 from screen 11 and pulling film 10 off screen 11.

While I have described the preferred embodiment of my invention, it will be evident to those skilled in the art that other embodiments may be possible within the scope of my invention.

What is claimed is:

1. A glare reducing film for application to a viewing screen of a device having a reflective viewing surface, comprising:
(a) a flexible, clear film sized to cover said viewing surface and having a matted front surface and a smooth back surface;
(b) a plurality of perforations extending through said film sized to permit the passage of air through said film; and
(c) a removable backing attached to said back surface of said film.

2. A glare reducing film according to claim 1, wherein said film comprises polyvinyl chloride.

3. A glare reducing film according to claim 1, wherein said film is formed in a convex shape corresponding to the convexity of said screen.

4. A glare reducing film according to claim 1, wherein said removable backing is scored diagonally from corner to corner to define a plurality of backing portions which may be peeled from said back surface of said film from the center of said film outwardly.

5. A glare reducing film for application to a viewing screen of a device having a reflective viewing surface, comprising:
(a) a flexible, clear film sized and shaped to cover said viewing surface and having a matted front surface and a smooth back surface;
(b) a plurality of perforations extending through and evenly spaced along said film and being sized to permit the passage of air through said film; and
(c) a removable backing attached to said back surface of said film, said backing being scored diagonally from corner to corner to define a plurality of backing portions which may be peeled from said back surface of said film from the center of said film outwardly.
